(19) United States
(12) Patent Application Publication
(10) Pub. No.: US 2008/0080767 A1
(43) Pub. Date: Apr. 3, 2008

(54) Method and apparatus for performing gamut mapping between heterogeneous devices

(75) Inventors: Min-ki Cho, Seoul (KR); Heui-keun Choh, Seongnam-si (KR); YouSun Bang, Seoul (KR); Se-eun Kim, Suwon-si (KR); Yun-tae Kim, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon (KR)

(21) Appl. No.: 11/902,934

(22) Filed: Sep. 26, 2007

(30) Foreign Application Priority Data
Sep. 29, 2006 (KR) 10-2006-0096300

(51) Int. Cl. H04N 1/60; G06T 11/00

(52) U.S. Cl. 382/167

(57) ABSTRACT

Provided is a method and apparatus to perform gamut mapping between heterogeneous devices, more particularly, a method and apparatus to map a color of a device to an identical or visually and sensually preferable color of another device having a different color gamut. The method includes adjusting lightness of a color of a source device by scaling to match a lightness range of the source device with a lightness range of a destination device; modifying the adjusted lightness of the color of the source device by adjusting a color gamut of the source device to a color gamut of the destination device; and to map the modified color of the source device to a color in the color gamut of the destination device.

### CROSS-REFERENCE TO RELATED APPLICATIONS

This application claims priority from Korean Patent Application No. 10-2006-0096300 filed on Sep. 29, 2006 in the Korean Intellectual Property Office, the disclosure of which is incorporated herein by reference in its entirety.

### BACKGROUND

1. Field of the Invention

The present invention relates to a method and apparatus to perform gamut mapping between heterogeneous devices, and more particularly, to a method and apparatus to map a color of a device to an identical or visually and sensually preferable color of another device having a different color gamut.

2. Description of the Related Art

Color input/output devices, which reproduce colors, such as monitors, cameras and printers, use different color spaces or models according to fields in which they are used. For example, in the case of a color image, printing devices use a cyan, magenta and yellow (CMY) color space, or a cyan, magenta, yellow and black (CMYK) color space while color cathode ray tube (CRT) monitors or computer graphics devices use a red, green and blue (RGB) color space. In order to define a device-independent color, which can be accurately reproduced anywhere regardless of devices, a CIE color space may be used. Major examples of the CIE color space include CIE-XYZ, CIE-Lab, CIE-Luv and CIECAMO2.

Apart from the color spaces, the color input/output devices may also have different ranges of reproducible colors, i.e., different color gamuts. Due to such differences in color gamut, the same image may look different from one color input/output device to another. Therefore, if a color signal is received from a source device having a different color gamut from that of a destination device which will reproduce the input color signal, it is required to appropriately convert the received color signal to match the color gamuts of the source and destination devices. This process is called “gamut mapping.”

For gamut mapping between, for example, a display and a color printer, the International Color Consortium (ICC), which is a color management standardization group, has standardized a technique of using a different gamut mapping method according to a rendering intent. The ICC recommends that a hue preserved minimum Delta E (HPMINDE) gamut mapping method should be used for a relative colormetric intent and that a sigmodial gaussian lightness mapping, cusp & knee (SGCK) gamut mapping method should be used for a perceptual intent.

However, if a natural color image on a display is output by a printer, which is a destination device, using the HPMINDE gamut mapping method or the SGCK gamut mapping method, the natural color image is distorted.

### SUMMARY

Additional aspects and/or advantages of the invention will be set forth in part in the description which follows and, in part, will be apparent from the description, or may be learned by practice of the invention.

It is an aspect of the present invention to enable a destination device to reproduce the color of a source device as similar as possible to the original color of the source device by adjusting the color gamut of the source device to that of the destination device.

It is another aspect of the present invention to prevent the generation of contours and paling of a pure color.

It is another aspect of the present invention to enable a destination device to output a visually and sensually preferable image by adjusting the shape of the color gamut of a source device and the compression rate for gamut mapping according to hue characteristics.

However, the aspects of the present invention are not restricted to the one set forth herein. The above and/or other aspects of the present invention will become more apparent to one of daily skill in the art to which the present invention pertains by referencing a detailed description of the present invention given below.

According to an aspect of the present invention, there is provided a method of performing gamut mapping between heterogeneous devices. The method includes scaling and thus adjusting lightness of a color of a source device in order to match a lightness range of the source device with a lightness range of a destination device; modifying the adjusted lightness of the color of the source device by adjusting a color gamut of the source device to a color gamut of the destination device; and mapping the modified color of the source device to a color in the color gamut of the destination device.

According to another aspect of the present invention, there is provided an apparatus to perform gamut mapping between heterogeneous devices. The apparatus includes a lightness adjustment module to adjust lightness of a color of a source device by scaling to match a lightness range of the source device with a lightness range of a destination device; a color gamut modification module to modify the adjusted lightness of the color of the source device by adjusting a color gamut of the source device to a color gamut of the destination device; and a gamut mapping module to map the modified color of the source device to a color in the color gamut of the destination device.

### BRIEF DESCRIPTION OF THE DRAWINGS

The patent or application file contains at least one drawing executed in color. Copies of this patent or patent application publication with color drawings will be provided by the Office upon request and payment of the necessary fee. These and/or other aspects and advantages of the invention will become apparent and more readily appreciated from the following description of the embodiments, taken in conjunction with the accompanying drawings of which:

FIG. 1 illustrates a conventional hue preserved minimum delta E (HPMINDE) gamut mapping method;

FIG. 2 illustrates a conventional sigmodial gaussian lightness mapping, cusp & knee (SGCK) gamut mapping method;

FIG. 3 is a flowchart illustrating a method of compensating a shadow region according to an embodiment of the present invention;

FIGS. 4A and 4B illustrate a sigmoid function and the distribution of weighting factors, which are used to scale lightness of a source device;

FIG. 5 illustrates a color gamut of the source device which was adjusted by scaling lightness of the source device;

FIG. 6 illustrates a color gamut of the source device which was modified by adjusting a cusp in the adjusted color gamut of the source device;

FIG. 7 illustrates a color gamut of the source device modified using an offset;

FIG. 8 illustrates an example of applying a different offset according to a hue;

FIG. 9 illustrates a gamut mapping process according to an embodiment of the present invention;

FIG. 10 illustrates an example of applying a different knee line according to a hue;

FIG. 11 illustrates color gamut boundaries obtained using different gamut mapping methods;

FIGS. 12A-12D illustrate images output using different gamut mapping methods; and

FIG. 13 is a block diagram of an apparatus to perform gamut mapping between heterogeneous devices according to an embodiment of the present invention.

### DETAILED DESCRIPTION OF THE PREFERRED EMBODIMENTS

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. Like reference numerals in the drawings denote like elements, and thus their description will be omitted.

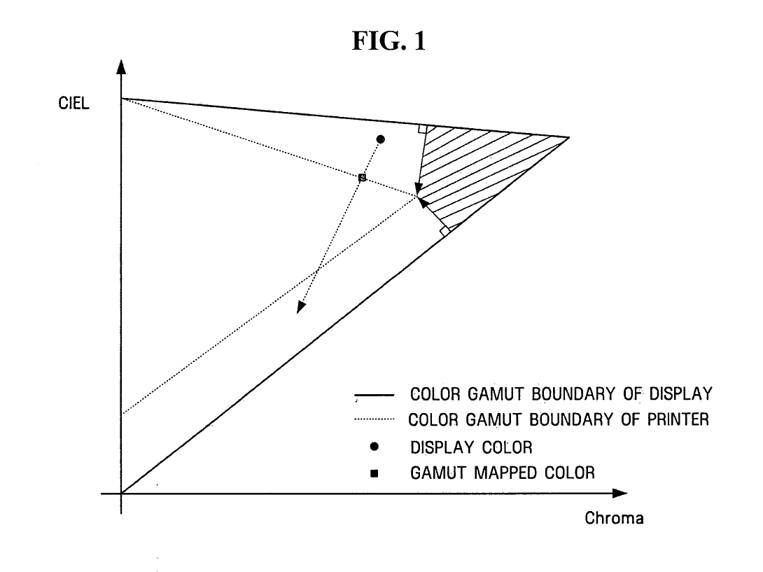

FIG. 1 illustrates a conventional hue preserved minimum delta E (HPMINDE) gamut mapping method.

Generally, a color gamut of a display is wider than that of a printer as illustrated in FIG. 1. Hence, not all colors from the display can be output by the printer. In the HPMINDE gamut mapping method, some of colors reproducible by the display, which fall outside the color gamut of the printer, are mapped to those having minimum color differences among colors reproducible by the printer. For example, referring to FIG. 1, a color of the display is outside the color gamut of the printer. If the color of the display is moved to a color having a minimum color difference, it may be mapped to a boundary line of the color gamut of the printer. However, if the color of the display is within the color gamut of the printer, it is not mapped and is maintained unchanged.

A drawback of the HPMINDE gamut mapping method is that colors in a region of the display, such as a hatched region in FIG. 1, is mapped to one gamut mapped color. Therefore, different colors on the display are output as the same color by the printer, thereby causing contours in an output image.

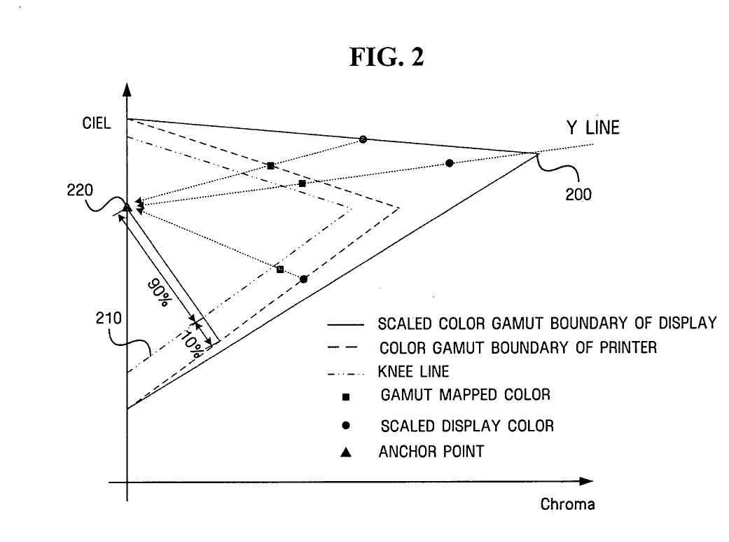

FIG. 2 illustrates a conventional sigmodial gaussian lightness mapping, cusp & knee (SGCK) gamut mapping method.

The conventional SGCK gamut mapping method may include an operation of scaling lightness of a color of a display and an operation of mapping the color with the scaled lightness.

Generally, a printer and a display have different lightness ranges. Therefore, the lightness of a color of the display color is scaled and thus adjusted in order to match the lightness range of a color gamut of the display with that of a color gamut of the printer.

In the color mapping operation, a color of the display may be compressed based on an anchor point 220. A knee line 210 is set at a position corresponding to 90% of a distance from the anchor point 220 to a color gamut boundary of the printer. If a scaled display color is inside the knee line 210, it is maintained unchanged. However, if the scaled display color is outside the knee line 210, it may be mapped using a compression technique. The knee line 210 denotes a line formed by connecting points located at a position corresponding to a percent (%) version of the distance between the anchor point 220 and the color gamut boundary.

If a pure color with high chroma is reproduced using the SGCK gamut mapping method, it may be mapped to a color with low chroma. In particular, if pure colors around a cusp 200 in the color gamut of the display are mapped using the SGCK gamut mapping method, the printer may output colors with relatively significantly lower chroma. In other words, paled pure colors may be reproduced.

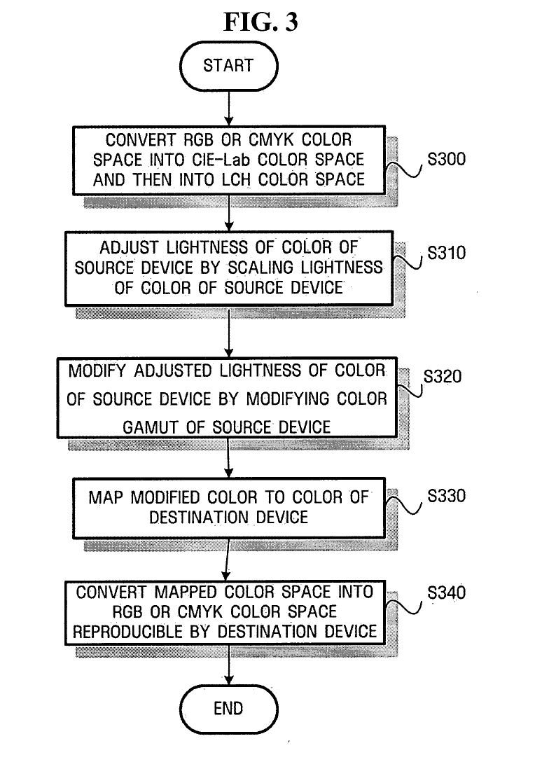

FIG. 3 is a flowchart illustrating a method of performing gamut mapping between heterogeneous devices according to an embodiment of the present invention.

Referring to FIG. 3, the method includes an operation of converting a color of a source device into a color in a color space having lightness, chroma and hue data (operation S300), an operation of scaling the lightness of a modified color based on a lightness range of a destination device (operation S310), modifying the scaled lightness of the color of the source device using a color gamut of the destination device (operation S320), an operation of mapping the color with the modified lightness to a color of the destination device (operation S330), and an operation of converting the color of the destination device into a color in a color space which can be output by the destination device (operation S340).

In the operation of converting the color of the source device into the color in the color space having lightness, chroma and hue components (operation S300), an input color signal of the source device is converted from a device-dependent color space, such as a red, green and blue (RGB) color space or a cyan, magenta, yellow and black (CMYK) color space, to a device-independent color space, such as a CIE-Lab color space, and then to a lightness, chroma and hue (LCH) coordinate system.

Specifically, an input color signal may be converted from the RGB or CMYK color space to the CIE-Lab color space. For such conversion, a standard chart may be color-measured using a colorimeter. Then, a mapping table between RGB or CMYK hues of the source device and CIE-Lab hues, which were color-measured by the colorimeter, may be created. Each of the CIE-Lab hues consists of luminosity, i.e., a lightness element L, and two tone elements a and b. Element a is positioned between green and red, and element b is positioned between blue and yellow.

After the RGB or CMYK color space is converted into the CIE-Lab color space, the CIE-lab color space may be converted into the LCH color space using a Lab value of the CIE-Lab color space as defined by Equation (1).

C=\sqrt{a²+b²}

H=tan⁻¹(b/a) (1)

where C indicates chroma, and H indicates hue. In the case of lightness, a value of the lightness element L, which represents lightness of Lab, may be used.

In a similar way, input RGB or CMYK data of the source device may be converted into JCh data having lightness, chroma and hue components. A color space having the JCh data is called a CIECAMO2 color space. In order to convert the RGB or CMYK data into the JCh data, the RGB or CMYK data is converted into XYZ data using the colorimeter, and then the XYZ data is converted again into the JCh data. For more detailed conversion process, “IEC TC-100, IEC 61966-2-1, Color Management Default RGB Color Space sRGB (1999)” may be referred to.

In the operation of scaling the lightness of the modified color based on the lightness range of the destination device (operation S310), the lightness range of the source device is scaled to that of the destination device, thereby adjusting the lightness of the color of the source device.

If the lightness range of the source device is wider than that of the destination device, the lightness of the color of the source device is scaled down to be within the lightness range of the destination device. Such scaling may be performed using Equation (2).

L_{sc}=(1−p_{c})Lₒᵣ+p_{c}Lₛ (2)

where L_{sc} indicates scaled and adjusted lightness, Lₒᵣ indicates lightness of the color of the source device, and Lₛ indicates lightness into which the lightness of the color of the source device was converted using a sigmoid function. In addition, p_{c} indicates a weighting factor and may be given by Equation (3).

$${p}_{c} = 1 - \sqrt{\frac{{C}^{3}}{{C}^{3} + 500 \text{,} 000}} . \qquad ( 3 )$$

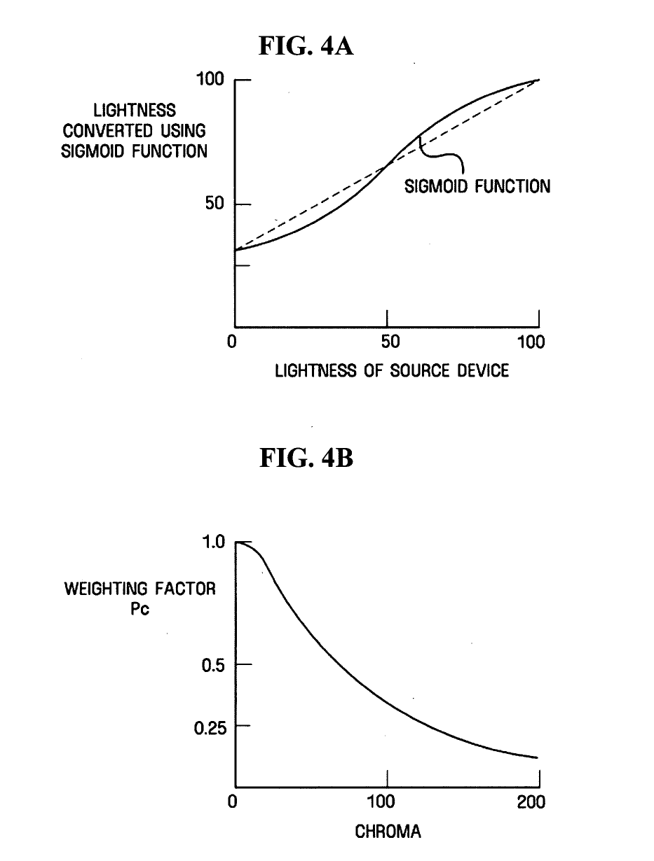

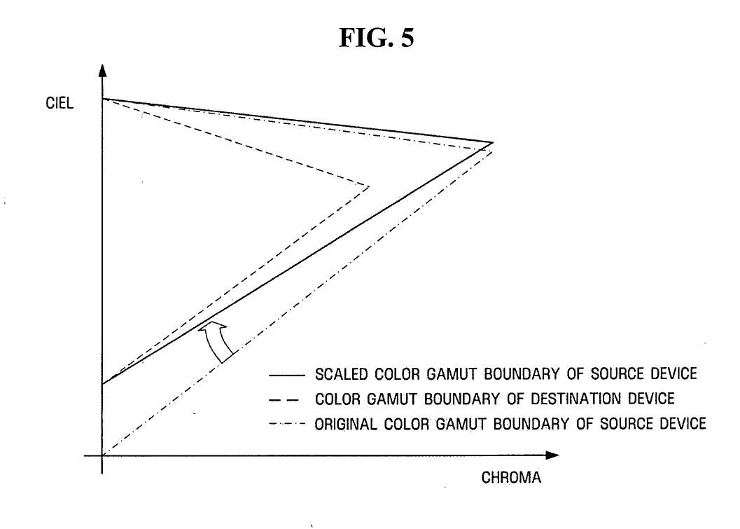

According to Equations (2) and (3), as chroma is closer to zero, L_{sc} becomes closer to Lₛ, and as chroma increases, L_{sc} becomes more affected by Lₒᵣ. In other words, as chroma is closer to zero, lightness is enhanced, and as chroma increases, the original lightness of an image is maintained. For example, if the lightness range of the source device is scaled using the sigmoid function and the weighting factor p_{c} illustrated in FIGS. 4A and 4B, the lightness range of the color gamut of the source device is adjusted to that of the color gamut of the destination device as illustrated in FIG. 5. Then, the lightness of the color of the source device may be adjusted to be within the lightness range of the color gamut of the destination device using Equation (2).

After the scaling operation (operation S310), a height (lightness) of a cusp of the source device is matched with that of a cusp of the destination device, thereby modifying the adjusted lightness of the color of the source device (operation S320). The cusp denotes an apex having highest chroma in a color gamut.

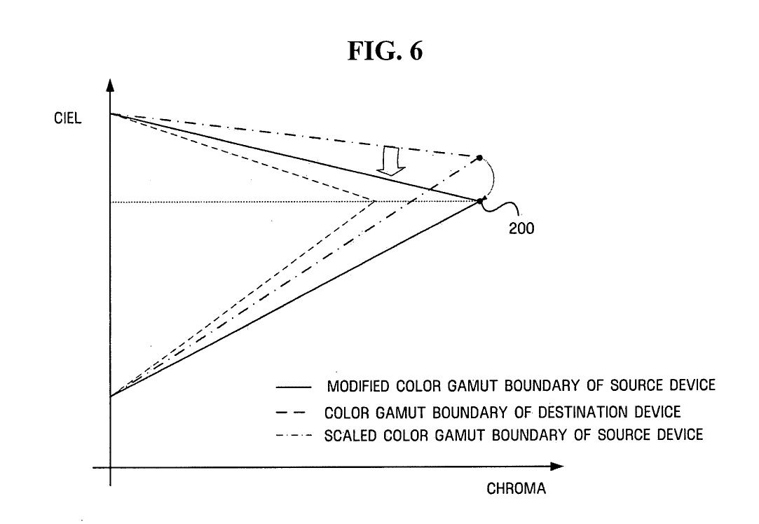

The color gamut of the source device may be modified by adjusting the position of the cusp of the source device to the position (lightness) of the cusp of the destination device. Accordingly, the lightness of the scaled color of the source device is modified. Such modification is performed to make a hue distribution of the source device similar to that of the destination device so that both devices produce similar color senses. Referring to FIG. 6, as a cusp 200 of the source device is adjusted, the color gamut of the source device is also adjusted. Therefore, a resultant color gamut of the source device has a similar shape to that of the color gamut of the destination device.

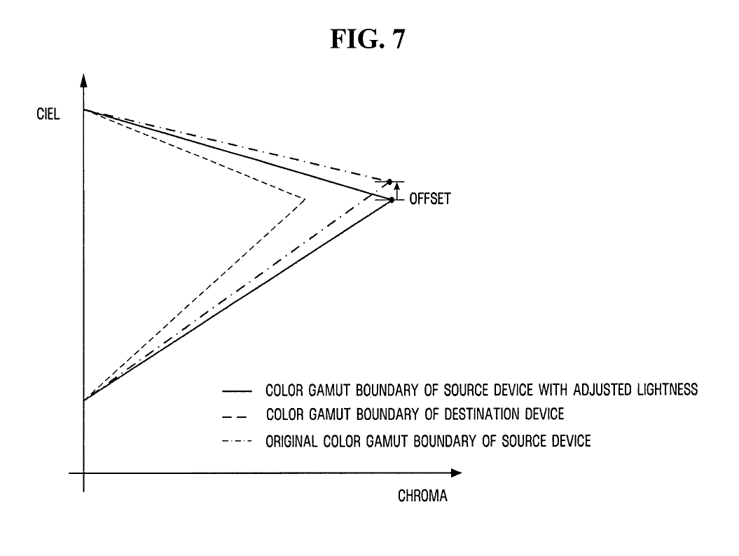

In another method of modifying the color gamut of the source device (operation S320), which is similar to the above method, an offset is used as illustrated in FIG. 7. Referring to FIG. 7, the lightness position of the cusp of the source device may be raised by the offset from the lightness position of the cusp of the destination device. Such adjustment is designed to prevent a pure color from being darkly reproduced when the pure color is mapped to a color of the destination device.

By adjusting the position of the cusp of the source device, the lightness of the color of the source device, which was adjusted in the scaling operation, can be modified. The adjusted lightness of the color of the source device may be modified using Equation (4).

$${L}_{mod} = {L}_{sc} \times ratio \\ ratio = 1 - ( 1 - \frac{{L}_{pr\_cusp} + offset}{{L}_{sc\_cusp}} ) \times ( \frac{{C}_{sc}}{{C}_{sc\_cusp}} ) , \qquad ( 4 )$$

where L_{mod} indicates modified lightness, ratio indicates a modification ratio, L_{sc}_{_{—}}_{cusp} indicates lightness of the adjusted cusp of the source device, and Lₚᵣ_{_{—}}_{cusp} indicates lightness of the cusp of the destination device. In addition, C_{sc} indicates chroma of the source device, C_{sc}_{_{—}}_{cusp} indicates chroma of the cusp of the source device, and offset indicates the difference between the modified lightness of the cusp of the source device and the lightness of the cusp of the destination device.

The result of adjusting the color gamut of the source device using the offset is illustrated in FIG. 7. When the color gamut of the source device is adjusted using the offset, the color of the source device can be modified to become relatively brighter than when the color gamut of the source device is adjusted without using the offset.

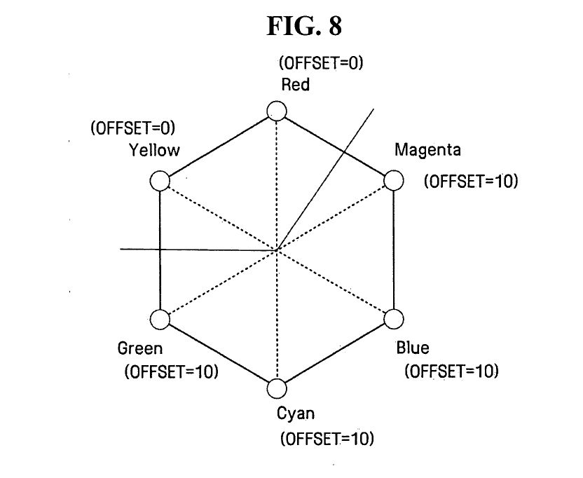

The size of the offset may vary according to a hue. For example, if pure colors reproduced by a printer, i.e., the destination device, are dark, such as green, cyan, blue and magenta, the offset may be set to a predetermined positive number (for example, ten as illustrated in FIG. 8). If the pure colors of the printer are bright, such as red and yellow, the offset may be set low (for example, zero as illustrated in FIG. 8). In addition, characteristics of each pure color of the destination device may be identified, and the offset may be set as a function. Then, different offsets may be applied to the pure colors, respectively.

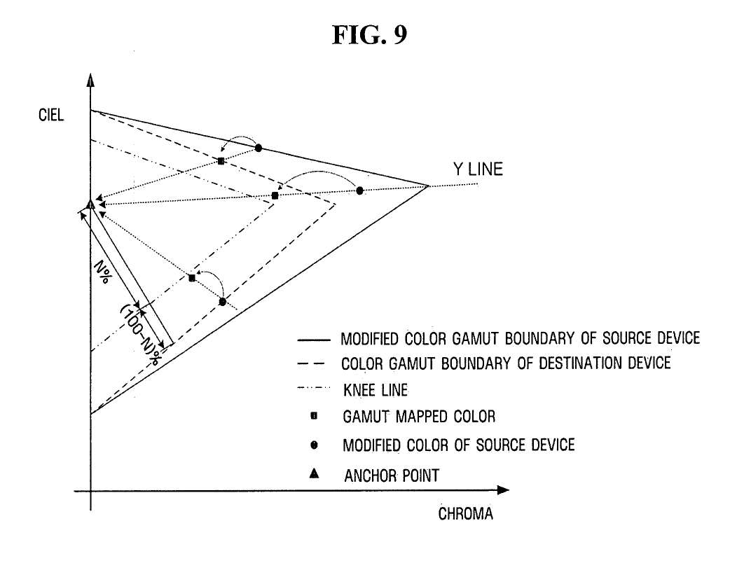

FIG. 9 illustrates a process of mapping a modified color of a source device to a color gamut of a destination device.

Referring to FIG. 9, a point having equal lightness to that of a cusp on a color gamut boundary of the destination device and having zero chroma is designated as an anchor point. A knee line is set at a position corresponding to N % of a distance from the set anchor point to the color gamut boundary of the destination device according to a hue.

If the modified color of the source device is inside the knee line, it is maintained unchanged. If the modified color of the source device is outside the knee line, it may be mapped using Equation (5) below.

$${d}_{pr\_color} = N ( \% ) / 100 \times {d}_{pr\_gb} + ( 100 - N ) ( \% ) / 100 \times \frac{( {d}_{di\_color} - N ( \% ) / 100 \times {d}_{pr\_gb} )}{( {d}_{di\_gb} - N ( \% ) / 100 \times {d}_{pr\_gb} )} , \qquad ( 5 )$$

where d indicates the distance between a point on a γ line and an anchor point. In addition, d_{di}_{_{—}}_{color} indicates the distance between a modified color of the source device on the γ line and the anchor point, d_{di}_{_{—}}_{gb} indicates the distance between a modified color gamut boundary of the source device on the γ line and the anchor point, dₚᵣ_{_{—}}_{gb} indicates the distance between the color gamut boundary of the destination device on the γ line and the anchor point, and dₚᵣ_{_{—}}_{color} indicates the distance between the anchor point and a mapped color point on the γ line. The modified color of the source device, which falls outside the knee line, may be mapped to a color located between the color gamut boundary of the destination device and the knee line using Equation (5) and the compression technique.

The setting of the knee line represents a compression range of the color gamut of the source device. For example, if the knee line is set to a position corresponding to 100% of the distance from the anchor point to the color gamut boundary of the destination device, the set knee line is the same as the color gamut boundary of the destination device. In this case, the color gamut of the source device is compressed, a clipping effect can be obtained. Clipping denotes mapping a point outside the color gamut boundary of the destination device to a point at which a virtual line extending from the point outside the color gamut boundary of the destination device to the anchor point intersects the color gamut boundary of the destination device. Therefore, if the knee line matches the color gamut boundary of the destination device and if colors outside the knee line are mapped to colors in the color gamut of the destination device, the colors outside the knee line are all mapped to the color gamut boundary of the destination device.

On the other hand, if the knee line is set to a position corresponding to 20% of the distance from the anchor point to the color gamut boundary of the destination device, a region inside the knee line is formed by connecting points located at the position corresponding to 80% of the distance from the anchor point to the color gamut boundary of the destination device. Therefore, the modified color of the source device outside the knee line can be mapped to a color between the knee line and the color gamut boundary of the destination device, that is, 20% of the distance from the color gamut boundary of the destination device to the anchor point.

Therefore, as illustrated in FIG. 9, three points representing modified colors of the source device may be mapped respectively to colors within the color gamut of the destination device. For mapping, the distance dₚᵣ_{_{—}}_{color} between the anchor point and a coordinate point of a mapped color may be calculated using Equation (5). Then, if a color is on the modified color gamut boundary of the source device, it may be mapped to the color gamut boundary of the destination device. If the modified color of the source device is on the color gamut boundary of the destination device, it may be modified to a color slightly outside the knee line.

In gamut mapping, a rate of the knee line may be vary according to a hue in order to consider hue characteristics of the destination device. For example, if the conventional HPMINDE or SGCK gamut mapping method is used, too reddish skin color may be output. In addition, a green grass region output by the destination device may be too saturated. In order to perform gamut mapping on yellow between red and green, a predetermined rate of the knee line may be set. For example, N may be in the range of 20% through 50%.

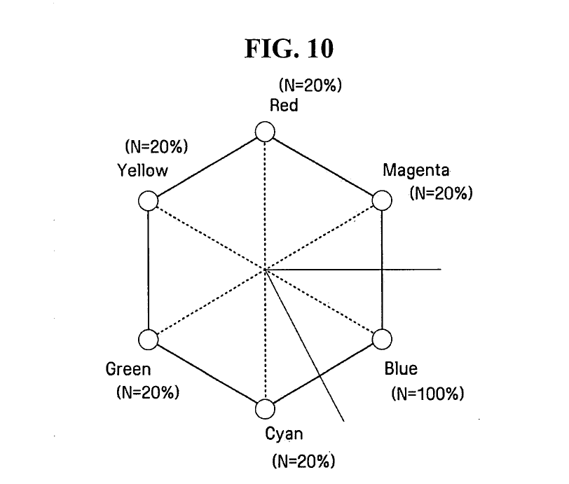

A blue region shows the greatest difference in color gamut when output by the display and when output by the printer. Therefore, if the compression technique is applied, the blue region may be darkly reproduced. However, if N is set to 100%, bright blue may be reproduced. As for a color between blue and yellow, the knee line may be adjusted using a linear function so that the color can be naturally mapped. In this way, the rate of the knee line may be set differently by reflecting the characteristics of each hue as illustrated in FIG. 10.

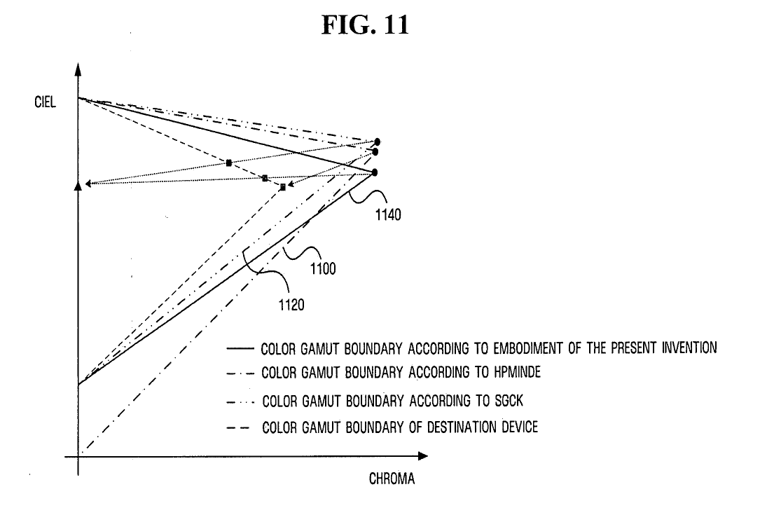

FIG. 11 illustrates color gamut boundaries obtained using different gamut mapping methods.

Referring to FIG. 11, a color gamut boundary 1100 obtained using the HPMINDE gamut mapping method corresponds to an original color gamut boundary of a source device. In the HPMINDE gamut mapping method, lightness is not scaled. Since a color of the source device is mapped to a color having a minimum color difference, points outside a color gamut of a destination device are all mapped to a color gamut boundary of the destination device. Furthermore, points around a cusp of the source device are all mapped to one cusp of the destination device, thereby causing contours. In the HPMINDE gamut mapping method, since colors outside the color gamut of the destination device are mapped to the color gamut boundary of the destination device, the colors outside the color gamut of the destination device are all expressed as a color on the color gamut boundary of the destination device, which has a minimum color difference. Consequently, different colors from the source device may frequently be reproduced as the same color by the destination device.

A color gamut boundary 1120 is obtained using the SGCK gamut mapping method. Since the color gamut boundary 1120 is adjusted by scaling lightness, a lightness range of the source device matches that of the destination device. In the SGCK gamut mapping method, gamut mapping is performed using the compression technique in color gamuts having the same lightness range. Referring to FIG. 11, if the cusp of the source device is gamut-mapped using the SGCK gamut mapping method, it is mapped to a point at which a virtual line extending from the cusp of the source device to an anchor point meets the color gamut boundary of the destination device. If the cusp of the source device, which corresponds to a pure color, is mapped, a paled pure color with significantly lower chroma may be reproduced.

A color gamut boundary 1140 obtained using the gamut mapping method according to the present invention is shaped relatively similar to that of the destination device since the lightness of the source device is scaled and then the lightness of the cusp of the source device is set equal to or higher, by an offset, than that of the destination device. After the modified color gamut boundary 1140 of the source device is obtained, gamut mapping is performed using the compression technique and based on the anchor point. Then, the destination device can represent a similar grayscale to that of the source device. In particular, the cusp of the source device can be mapped to a color slightly brighter and having lower chroma than the cusp of the destination device. Therefore, a pure color, which is not dark and has relatively high chroma, can be reproduced.

Referring to FIG. 3, a mapped color is converted into a color in a color space which can be output by the destination device (operation S340). The mapped color corresponds to a point in the LCH or CIECAMO2 color space having lightness, chroma and hue components. Therefore, the mapped color can be converted into a value of the RGB or CMYK color space output by the destination device. This operation is a reverse operation to the operation of converting a color of the source device into a color in the LCH color space.

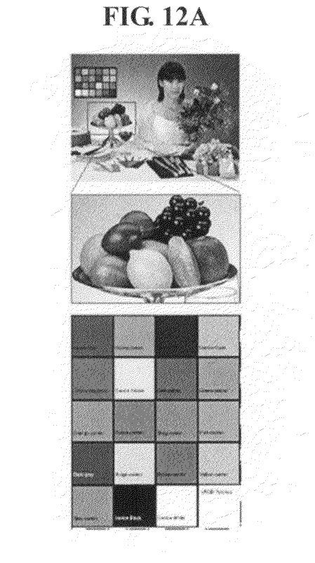

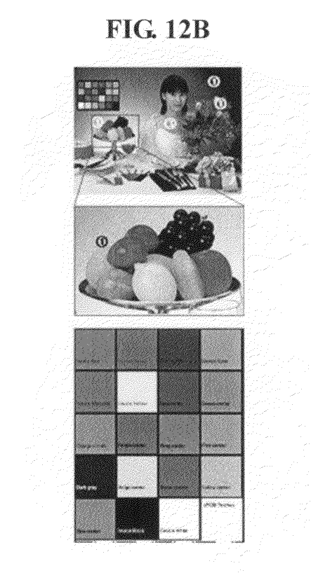

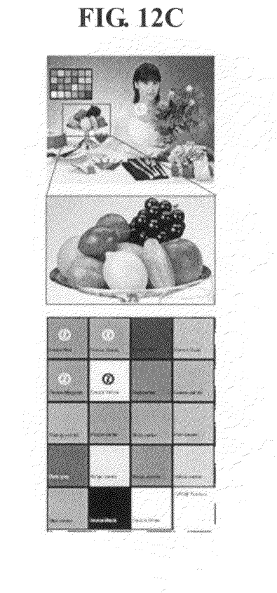

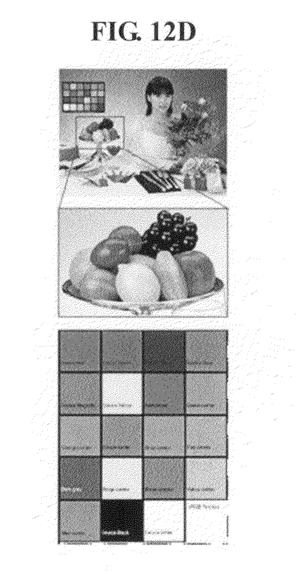

FIG. 12A-2D illustrate images output using different gamut mapping methods. FIG. 12A illustrates a display image, and FIG. 12B illustrates an image output using the conventional HPMINDE gamut mapping method. In addition, FIG. 12C illustrates an image output using the SGCK gamut mapping method, and FIG. 12D illustrates an image output using a gamut mapping method according to an embodiment of the present invention.

Referring to FIG. 12B, a converted color is concentrated in a region where red fruit is output, thereby causing contours in the image. In the image of FIG. 12C, a bright pure color with low chroma was not properly reproduced. In particular, pure colors such as red, green, yellow and yellowish green were not properly expressed. In addition, a skin color of a person reproduced in the images of FIGS. 12B and 12C is too reddish.

In the image of FIG. 12D, pure colors, such as red, green, yellow and yellowish green, were reproduced to have high lightness and chroma, and natural gradation without contours was expressed.

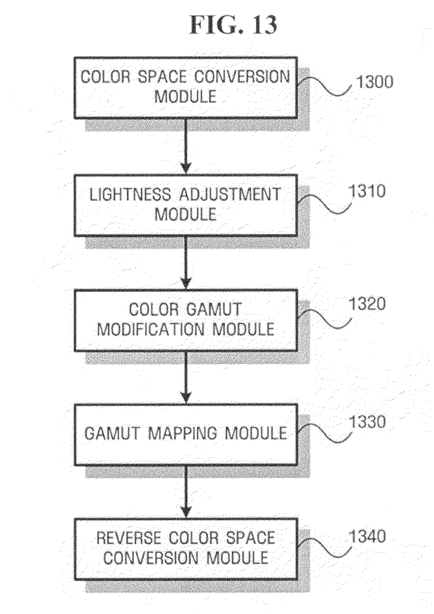

FIG. 13 is a block diagram of an apparatus to perform gamut mapping between heterogeneous devices according to an embodiment of the present invention.

Referring to FIG. 13, the apparatus includes a color space conversion module 1300, a lightness adjustment module 1310, a color gamut modification module 1320, a gamut mapping module 1330, and a reverse color space conversion module 1340.

The color space conversion module 1300 converts color data of a source device from an RGB or CMYK color space to an LCH or CIECAMO2 color space. In order to convert the RGB or CMYK color space into the LCH color space, the color space conversion module 1300 converts the color data from the RGB or CMYK color space into a CIE-Lab color space and then into an LCH coordinate system. Specifically, a mapping table between RGB or CMYK hues of the source device and CIE-Lab hues, which were color-measured by a calorimeter, may be created. Then, after the RGB or CMYK color space is converted into the CIE-Lab color space, the CIE-lab color space may be converted into the LCH color space using Equation (1).

In order to convert the RGB or CMYK color space into the CIECAMO2 color space, the RGB or CMYK data is converted into XYZ data using a mapping table, which was color-measured by the colorimeter, and then the XYZ data is converted into JCh data. Consequently, lightness, chroma and hue of a corresponding color can be obtained.

The lightness adjustment module 1310 scales the lightness of a converted color based on a lightness range of the destination device. The lightness adjustment module 1310 may scale a lightness range of the source device to that of the destination device using Equations (2) and (3). Consequently, the lightness adjustment module 1310 matches the lightness range of the color gamut of the source device with that of the color gamut of the destination device as illustrated in FIG. 5.

The color gamut modification module 1320 modifies the scaled lightness of the color of the source device by matching the height (lightness) of a cusp in a color gamut of the source device with that of a cusp of the destination device. In another modification method, the color gamut modification module 1320 may use an offset in order to prevent a pure color from being darkly mapped. Specifically, the color gamut modification module 1320 may set the height of the cusp of the source device higher than that of the cusp of the destination device by the offset. Then, points including the cusp of the source device may be multiplied by a ratio, which is calculated using Equation (4). As a result, the scaled lightness may be modified. In addition, the size of the offset may be adjusted according to hue characteristics, thereby adjusting the color gamut of the source device.

The gamut mapping module 1330 maps points in the color gamut of the source device modified by the color gamut modification module 1320, which are outside a knee line, to the color gamut of the destination device based on an anchor point. If the color of the source device, which was modified by the color gamut modification module 1320, is inside the knee line, it is maintained the same. If the modified color of the source device is outside the knee line, the distance from the anchor point to the color of the source device is calculated using Equation (5). As a result, a color to which the modified color of the source device is mapped can be obtained. The rate of the knee line may be adjusted so that the degree of compression applied to gamut mapping can be controlled according to a hue. The rate of the knee line may vary according to the hue characteristics.

The reverse color space conversion module 1340 converts points in a mapped color space into points in the RGB or CMYK color space which can be output by the destination device. This operation is a reverse operation to the operation of converting the color data in the RGB or CMYK color space into a point in the LCH or CIECAMO2 color space, which is performed by the color space conversion module 1300.

The term ‘module’, as used herein, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and the modules may be implemented to execute one or more central processing units (CPUS) in a device.

As described above, an aspect of the present invention provides at least one of the following advantages.

First, since a color gamut of a source device is scaled to become similar to that of a destination device, the destination device can express natural and smooth gradation.

Second, the generation of contours, which is a problem of the conventional HPMINDE gamut mapping method, and the reproduction of a paled pure color, which is a problem of the conventional SGCK gamut mapping method, can be prevented.

Third, since the size of an offset and a rate of a knee line are adjusted according to characteristics of each hue, the destination device can output a generally accurate and visually and sensually preferable image.

However, the effects of the present invention are not restricted to the one set forth herein. The above and other effects of the present invention will become more apparent to one of daily skill in the art to which the present invention pertains by referencing the claims of the present invention given below.

While the present invention has been particularly shown and described with reference to exemplary embodiments thereof, it will be understood by those of ordinary skill in the art that various changes in form and details may be made therein without departing from the spirit and scope of the present invention as defined by the following claims. The exemplary embodiments should be considered in descriptive sense only and not for purposes of limitation.

1. A method of performing gamut mapping between heterogeneous devices, the method comprising:
adjusting lightness of a color of a source device by scaling to match a lightness range of the source device with a lightness range of a destination device;
modifying the adjusted lightness of the color of the source device by adjusting a color gamut of the source device to a color gamut of the destination device; and
mapping the modified color of the source device to a color in the color gamut of the destination device.

2. The method of claim 1, wherein the adjusting lightness of the color comprises adjusting the lightness of the color of the source device by combining the lightness of the color of the source device and lightness into which the lightness of the color of the source device was converted using a sigmoid function.

3. The method of claim 1, wherein the modifying adjusted lightness of the color of the source device comprises modifying the lightness of the color of the source device, which was adjusted in the adjusting lightness of the color, by adjusting the color gamut of the source device such that a cusp of the color gamut of the source device can match a cusp of the color gamut of the destination device.

4. The method of claim 1, wherein the modifying adjusted lightness of the color of the source device comprises modifying the lightness of the color of the source device, which was adjusted in the adjusting lightness of the color, by adjusting the color gamut of the source device such that the cusp of the color gamut of the source device can be moved to a position higher than the cusp of the color gamut of the destination device by a predetermined offset in a lightness direction.

5. The method of claim 4, wherein a value of the predetermined offset varies according to a hue.

6. The method of claim 1, wherein mapping the modified color comprises mapping the modified color to an identical color if the modified color is inside a knee line of the destination device and mapping the modified color by compressing the modified color in proportion to a distance between the modified color and an anchor point if the modified color is outside the knee line of the destination device.

7. The method of claim 6, wherein a rate of the knee line varies according to a hue.

8. The method of claim 1, further comprising:
converting an input red, green and blue (RGB) color space or a cyan, magenta, yellow and black (CMYK) color space of the source device into a Lab color space; and
converting the Lab color space into a lightness, chroma and hue (LCH) color space.

9. The method of claim 8, further comprising:
converting a color from the LCH color space, which was mapped to be reproducible by the destination device, into the Lab color space; and
converting the Lab color space into the RGB or CMYK color space.

10. The method of claim 1, further comprising converting the input RGB or CMYK color space of the source device into a CIECAMO2 color space having JCh data which is defined by lightness, chroma and hue.

11. The method of claim 10, further comprising converting the JCh data in the CIECAMO2 color space, which was mapped to be reproducible by the destination device, into data in the RGB or CMYK color space.

12. An apparatus to perform gamut mapping between heterogeneous devices, the apparatus comprising:
a lightness adjustment module to adjust lightness of a color of a source device by scaling to match a lightness range of the source device with a lightness range of a destination device;
a color gamut modification module to modify the adjusted lightness of the color of the source device by adjusting a color gamut of the source device to a color gamut of the destination device; and
a gamut mapping module to map the modified color of the source device to a color in the color gamut of the destination device.

13. The apparatus of claim 12, wherein the lightness adjustment module adjusts the lightness of the color of the source device by combining the lightness of the color of the source device and lightness into which the lightness of the color of the source device was converted using a sigmoid function.

14. The apparatus of claim 12, wherein the color gamut modification module modifies the lightness of the color of the source device, which was adjusted by the lightness adjustment module, by adjusting the color gamut of the source device such that a cusp of the color gamut of the source device can match a cusp of the color gamut of the destination device.

15. The apparatus of claim 12, wherein the color gamut modification unit modifies the lightness of the color of the source device, which was adjusted by the lightness adjustment module, by adjusting the color gamut of the source device such that the cusp of the color gamut of the source device can be moved to a position higher than the cusp of the color gamut of the destination device by a predetermined offset in a lightness direction.

16. The apparatus of claim 15, wherein a value of the predetermined offset varies according to a hue.

17. The apparatus of claim 12, wherein the gamut mapping module maps the modified color to an identical color if the modified color is inside a knee line of the destination device and mapping the modified color by compressing the modified color in proportion to a distance between the modified color and an anchor point if the modified color is outside the knee line of the destination device.

18. The apparatus of claim 17, wherein a rate of the knee line varies according to a hue.

19. The apparatus of claim 12, further comprising a color space conversion module to convert an input RGB color space or a CMYK color space of the source device into a Lab color space and converting the Lab color space into an LCH color space.

20. The apparatus of claim 19, further comprising a reverse color space conversion module to convert a color from the LCH color space, which was mapped to be reproducible by the destination device, into the Lab color space and to convert the Lab color space into the RGB or CMYK color space.

21. The apparatus of claim 12, further comprising a color space conversion module to convert the input RGB or CMYK color space of the source device into a CIECAMO2 color space having JCh data which is defined by lightness, chroma and hue.

22. The apparatus of claim 21, further comprising a reverse color space conversion module to convert the JCh data in the CIECAMO2 color space, which was mapped to be reproducible by the destination device, into data in the RGB or CMYK color space.
